(19) United States
(12) Patent Application Publication
(10) Pub. No.: US 2022/0147183 A1
(43) Pub. Date: May 12, 2022

(54) TOUCH PANEL AND TOUCH DETECTION METHOD

(71) Applicant: SHENZHEN ROYOLE TECHNOLOGIES CO., LTD., Shenzhen, Guangdong (CN)

(72) Inventor: Xiaohua LEI, Shenzhen, Guangdong (CN)

(21) Appl. No.: 17/413,455

(22) PCT Filed: Dec. 13, 2018
(86) PCT No.: PCT/CN2018/120866

§ 371 Date: Jan. 27, 2022

(51) Int. Cl. G06F 3/044; G06F 3/041

(52) U.S. Cl. CPC G06F 3/0445; G06F 2203/04105; G06F 3/04164

(57) ABSTRACT

The present disclosure discloses a touch panel (103), including a base (10) and an electrode unit (30) arranged on the base (10), where the electrode unit (30) includes a first sub-electrode (31) and a second sub-electrode (33) that are oppositely arranged at an interval. When the electrode unit (30) is stressed, a distance or a relative area between the first sub-electrode (31) and the second sub-electrode (33) changes and causes a change in a capacitance between the first sub-electrode (31) and the second sub-electrode (33), so that pressure-sensitive touch control is implemented, ensuring touch control performance of the touch panel and lowering process control requirements. The present disclosure further provides a touch detection method.

### TECHNICAL FIELD

The present disclosure relates to the field of touch technologies, and in particular, to a touch panel and a touch detection method.

### BACKGROUND

At present, more and more electronic apparatuses are provided with touch screens to provide touch functions for good human-machine interaction. Most of existing touch screens have planar structures. However, many mainstream electronic products will take a curved surface design in the future. Therefore, how to apply touch screens to curved surfaces has attracted wide attention. Existing planar touch screens mainly employ self-capacitance and mutual-capacitance technologies. Deformation of each layer of material caused by bending of the planar structure easily causes thickness deformations and different thicknesses to upper and lower electrodes and an intermediate dielectric layer, affecting touch control performance.

### SUMMARY

To solve the above-mentioned problems, the embodiments of the present disclosure disclose a touch panel and a touch detection method that ensure touch control performance.

The touch panel includes a base and electrode units arranged on the base, where the electrode units each include a first sub-electrode and a second sub-electrode that are arranged opposite to each other at an interval, and when the electrode unit is pressed, a distance or a relative area between the first sub-electrode and the second sub-electrode changes and causes a change in a capacitance between the first sub-electrode and the second sub-electrode.

The touch detection method includes: receiving an external touch over electrode units, where the electrode units each include a first sub-electrode and a second sub-electrode that are arranged opposite to each other at an interval, and a distance or a relative area between the first sub-electrode and the second sub-electrode changes upon the external touch and causes a change in a capacitance between the first sub-electrode and the second sub-electrode; and detecting the external touch based on the change in the capacitance between the first sub-electrode and the second sub-electrode.

According to the touch panel and the touch detection method provided in the present disclosure, electrode units each include a first sub-electrode and a second sub-electrode that are arranged opposite to each other at an interval. When the electrode unit is pressed, a distance or a relative area between the first sub-electrode and the second sub-electrode changes and causes a change in a capacitance between the first sub-electrode and the second sub-electrode, so that pressure-sensitive touch control is implemented, which facilitates implementation of a touch function of the touch panel, and prevents touch control performance from being affected when each layer of material of the electrode units is deformed.

### BRIEF DESCRIPTION OF DRAWINGS

To describe the technical solutions in the embodiments of the present disclosure more clearly, the following briefly describes the accompanying drawings required for describing the embodiments. Apparently, the accompanying drawings in the following description show merely some embodiments of the present disclosure, and a person of ordinary skill in the art may still derive other drawings from these accompanying drawings without creative efforts.

FIG. 1 is a structural block diagram illustrating a touch apparatus according to a first implementation of the present disclosure;

FIG. 2a is an isometric schematic diagram illustrating the touch panel according to the first implementation of the present disclosure;

FIG. 2b is a schematic diagram illustrating stress directions of the touch panel calculated by using triangulation weights;

FIG. 2c is a schematic diagram illustrating a first arrangement of three adjacent electrode units on the touch panel;

FIG. 2d is a schematic diagram illustrating a second arrangement of three adjacent electrode units on the touch panel;

FIG. 2e is a schematic diagram illustrating a third arrangement of three adjacent electrode units on the touch panel;

FIG. 3 is a schematic diagram illustrating an electrode unit according to the first implementation of the present disclosure;

FIG. 4 is a schematic sectional view illustrating the electrode unit according to the first implementation of the present disclosure;

FIG. 5a is a schematic sectional view illustrating a first sub-electrode according to the first implementation of the present disclosure;

FIG. 5b is a schematic sectional view illustrating a second sub-electrode according to the first implementation of the present disclosure;

FIG. 5c is a schematic sectional view illustrating a spacer layer according to the first implementation of the present disclosure;

FIG. 6 is a schematic sectional view illustrating a prefabricated electrode unit according to an implementation of the present disclosure;

FIG. 7 is a schematic diagram illustrating projections of a common electrode layer, a first electrode layer, and a second electrode layer of the electrode unit shown in FIG. 3;

FIG. 8a is a schematic diagram illustrating a projection of an electrode unit when the electrode unit is deformed under pressure according to an implementation of the present disclosure;

FIG. 8b is another schematic diagram illustrating a projection of an electrode unit when the electrode unit is deformed under pressure according to an implementation of the present disclosure;

FIG. 8c is a schematic diagram illustrating a direction in which an electrode unit slides upon a pressure touch;

FIG. 9 is a schematic sectional view illustrating an electrode unit according to a second implementation of the present disclosure;

FIG. 10a is a schematic sectional view illustrating a first sub-electrode according to the second implementation of the present disclosure;

FIG. 10b is a schematic sectional view illustrating a second sub-electrode according to the second implementation of the present disclosure;

FIG. 10c is a schematic sectional view illustrating a spacer layer according to the second implementation of the present disclosure;

FIG. 11 is a schematic sectional view illustrating a prefabricated electrode unit according to an implementation of the present disclosure;

FIG. 12 is a schematic diagram illustrating projections of a common electrode layer, a first electrode layer, and a second electrode layer of the electrode unit shown in FIG. 9; and

FIG. 13 is a flowchart illustrating a touch detection method according to an implementation of the present disclosure.

### DESCRIPTION OF EMBODIMENTS

The following clearly and completely describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

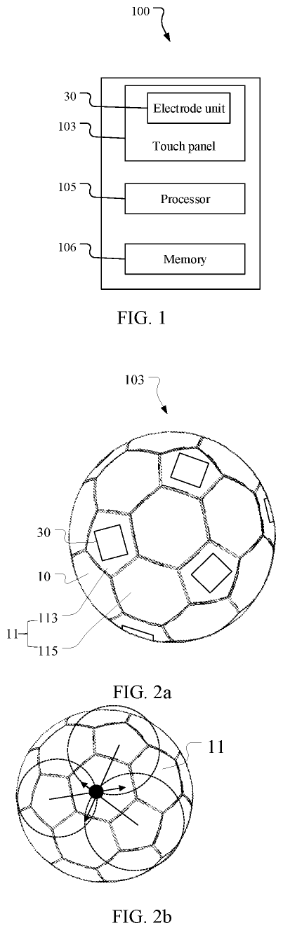

FIG. 1 is a structural block diagram illustrating a touch apparatus according to a first implementation of the present disclosure. The touch apparatus 100 includes a touch panel 103 and a processor 105 electrically connected to the touch panel 103. The touch panel 103 is configured to generate a touch signal in response to a user's pressure touch. The processor 105 is configured to receive the touch signal generated by the touch panel 103 in response to the user's pressure touch on the touch panel 103, to determine touch parameters input by the user's touch, and perform corresponding control operations based on the touch parameters.

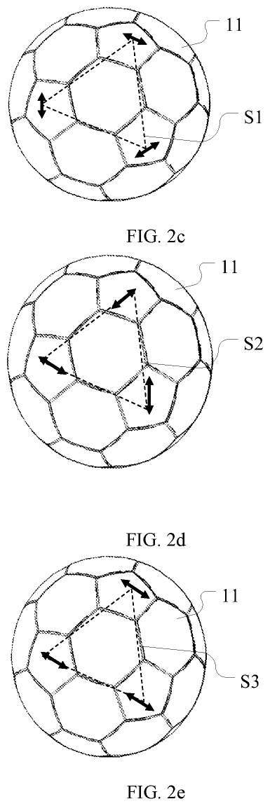

FIG. 2a is an isometric schematic diagram illustrating the touch panel according to the first implementation of the present disclosure. The touch panel 103 includes a base 10 and a plurality of electrode units 30. The base 10 includes a curved surface 11, i.e., the touch panel 103 is a curved-surface touch panel. In the implementation, the base 10 has a spherical structure, and the curved surface 11 is a spherical curved surface. In other implementations, the base 10 may have other curved-surface structures, and there may be one, two, or more curved surfaces 11.

The plurality of electrode units 30 are attached to the outermost side of the curved surface 11 and are independent of each other without overlapping. The electrode units 30 each change its capacitance when stressed and deformed, thereby implementing pressure-sensitive touch control. The changed capacitance of the electrode unit 30 serves as a touch signal that can be detected by the processor 105. The plurality of electrode units 30 are assembled and attached to the curved surface 11 to form the touch panel 103. Such practice reduces a deformation degree of an electrode material caused by attachment in bending state, reduces the impact of a large-scale deformation on performance of electrode pattern, ensures touch control performance of the touch panel 103, lowers process control requirements, and facilitates preparation of the touch panel 103. In addition, the pressure-sensitive touch control mode facilitates implementation of a touch function of the touch panel 103, and prevents touch performance from being affected when each layer of material of the electrode units 30 is deformed.

Specifically, the curved surface 11 includes a plurality of first regions 113 and a plurality of second regions 115. The first regions 113 each are surrounded by a plurality of second regions 115, and each of the electrode units 30 is arranged in one of the first regions 113. In the implementation, the first regions 113 each are an equilateral pentagonal region, the second regions 115 each are an equilateral hexagonal region, one first region 113 is surrounded by five second regions 115, and a side of each of the first regions 113 is a side of an adjacent second region 115. In some embodiments, there are 12 first regions 113 and 20 second regions 115. It can be understood that, the first regions 113 and the second regions 115 may have other shapes and different numbers.

In some embodiments, the plurality of electrode units 30 are disposed in the plurality of first regions 113 respectively, i.e., each first region 113 is provided with one electrode unit 30. Lines connecting respective central positions of three adjacent electrode units 30 form a triangle, and three or more electrode units 30 are jointly subjected to a pressure touch and deform. Based on a change in a capacitance of each electrode unit 30, the processor 105 performs calculation by using a preset algorithm (such as triangulation weighting, as shown in FIG. 2b) to determine a stress center and a stress direction. In the implementation, the electrode units 30 are distributed on the touch panel 103 in divided regions, for example, the electrode units 30 are distributed in a manner of special equilateral triangulation. Instead of arranging one electrode unit 30 in each region, the electrode units 30 may be arranged only in the first regions 113, thereby effectively reducing the number of electrode units 30, and reducing manufacturing process difficulty and production costs.

FIG. 2c to FIG. 2e are schematic diagrams illustrating arrangements of three adjacent electrode units on the curved surface. Dotted lines indicate a triangle formed by connecting respective central positions of three adjacent electrode units 30. Directions indicated by the arrows represent arrangement directions of the electrode units 30, and the arrangement directions each are parallel to an extension direction of a long side of the electrode unit 30. In the implementation, the arrowed directions pass through the central positions of the electrode units 30. For example, in a first arrangement, as shown in FIG. 2c, the arrangement directions of the three adjacent electrode units 30 are different, the arrangement directions of the three adjacent electrode units 30 form included angles with each other, and none of the arrangement directions of the three adjacent electrode units 30 are parallel to (or coincide with) any side of a triangle S1 formed by lines connecting the respective central positions of the three adjacent electrode units 30. For another example, in a second arrangement, as shown in FIG. 2d, the arrangement directions of the three adjacent electrode units 30 are different, and the arrangement direction of each electrode unit 30 is parallel to (or coincides with) one side of a triangle S2 formed by lines connecting the respective central positions of the three adjacent electrode units 30. For another example, in a third arrangement, as shown in FIG. 2e, the arrangement directions of the three adjacent electrode units 30 are parallel to each other, and arrangement directions of two of the three electrode units 30 coincides with (or is parallel to) one side of a triangle S3. In the first arrangement and the second arrangement, the arrangement directions of the three electrode units 30 are different, and an extension line of the arrangement direction of each electrode unit 30 intersects with extension lines of the arrangement directions of the other two electrode units 30 to jointly form a triangle, which is beneficial to detect the stress direction of the touch panel 103. In the third arrangement, because the arrangement directions of the two electrode units 30 are parallel to one side of the triangle S3, it is not conducive to determining and detecting the stress direction by using the triangulation weighting method.

Preferably, the three adjacent electrode units 30 are such arranged that the extension lines of the arrangement directions of the three electrode units 30 can jointly form a triangle.

It can be understood that, alternatively, an electrode unit 30 may further be attached to each second region 115, and lines connecting central positions of three adjacent electrode units 30 in the second regions 115 also form a triangle, so as to increase touch points on the curved surface 11 to improve the touch performance.

It can be understood that, in some embodiments, an electrode unit 30 may alternatively be arranged only in each second region 115, and lines connecting central positions of three adjacent electrode units 30 in the second regions 115 form a triangle.

FIG. 3 is a schematic diagram illustrating an electrode unit according to the first implementation of the present disclosure. The electrode unit 30 includes a first sub-electrode 31 and a second sub-electrode 33 that are stacked and insulated. The first sub-electrode 31 includes a common electrode layer 311, and the second sub-electrode 33 includes a first electrode layer 331 and a second electrode layer 333 that are insulated from each other. The common electrode layer 311 is arranged opposite to the first electrode layer 331 to form a first capacitor, and the common electrode layer 311 is arranged opposite to the second electrode layer 333 to form a second capacitor. When the electrode unit 30 is deformed under pressure, a capacitance of at least one of the first capacitor and the second capacitor of the electrode unit 30 changes.

In the implementation, the common electrode layer 311 is arranged adjacent to the outermost side of the touch panel 103, i.e., the common electrode layer 311 is arranged at a position of the touch panel 103 on a further outer side relative to the first electrode layer 331 and the second electrode layer 333. When the common electrode layer 311 is deformed under pressure, the capacitances of the first capacitor and the capacitance of the second capacitor both change, helping determine a touch position and a touch sliding direction. In addition, because the first capacitor and the second capacitor share the common electrode layer 311, an electrode material can be further reduced.

In another implementation, the first electrode layer 331 and the second electrode layer 333 are arranged adjacent to the outermost side of the touch panel 103, i.e., the first electrode layer 331 and the second electrode layer 333 are arranged at a position of the touch panel 103 on a further outer side relative to the common electrode layer 311. If the first electrode layer 331 is deformed under pressure, the capacitance of the first capacitor changes, and if the second electrode layer 333 is deformed under pressure, the capacitance of the second capacitor changes. As such, the number of touch points of the touch panel 103 is increased and sensitivity of the touch panel 103 is improved.

In the implementation, the electrode unit 30 has a curved structure with a certain curvature, and the first sub-electrode 31 and the second sub-electrode 33 have the same curvature as the electrode unit 30. It can be understood that, the present disclosure sets no limitation on whether the first sub-electrode 31, the second sub-electrode 33, and the electrode unit 30 have the same curvature. The first sub-electrode 31, the second sub-electrode 33, and the electrode unit 30 may also have a planar structure, i.e., the electrode unit 30 may alternatively be arranged on a plane, and the touch panel 103 is a planar touch panel, provided that the capacitance of the first capacitor and the capacitance of the second capacitor both change when the electrode unit 30 is stressed and deformed.

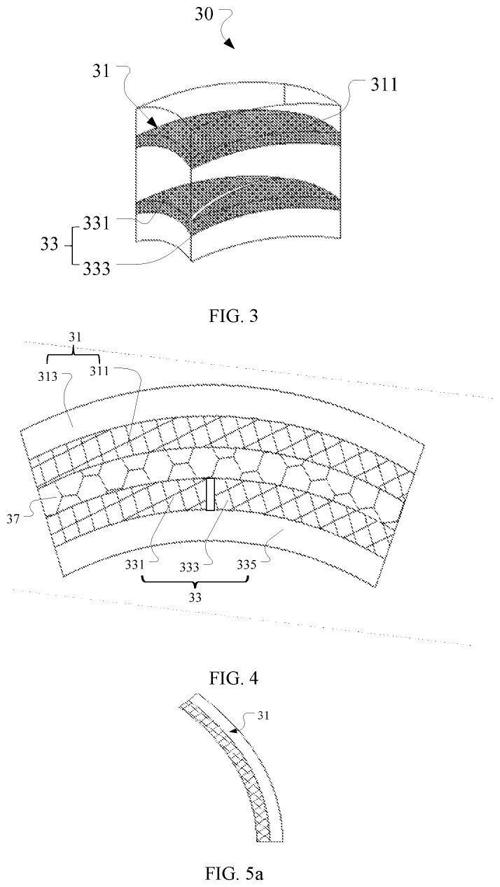

FIG. 4 is a schematic sectional view illustrating an electrode unit 30 according to the first implementation of the present disclosure. The first sub-electrode 31 further includes a first insulating base material layer 313, and the common electrode layer 311 is formed by preparing a conductive material on the first insulating base material layer 313 by using a process of deposition, printing, coating, or calendering. The second sub-electrode 33 further includes a second insulating base material layer 335, and the first electrode layer 331 and the second electrode layer 333 are formed in different regions on the same surface of the second insulating base material layer 335. Similarly, both the first electrode layer 331 and the second electrode layer 333 are formed by preparing a conductive material on the second insulating base material layer 335 by using a process of deposition, printing, coating, or calendering. The conductive material is, for example, conductive ink, conductive paste, conductive oxide, metal, metal oxide, or a combination thereof. A material for manufacturing the first insulating base material layer 313 and the second insulating base material layer 335 is a non-conductive insulating material such as PET, PC, PMMA, ceramic, or glass.

The electrode unit 30 further includes a spacer layer 37, the common electrode layer 311 is disposed on one side of the spacer layer 37, and the first electrode layer 331 and the second electrode layer 333 are disposed on the other side of the spacer layer 37 away from the common electrode layer 311. The common electrode layer 311 is spaced and insulated from the first electrode layer 331 and the second electrode layer 333 through the spacer layer 37, the common electrode layer 311 and the first electrode layer 331 form the first capacitor, and the common electrode layer 311 and the second electrode layer 333 form the second capacitor. The common electrode layer 311 is located between the first insulating base material layer 313 and the spacer layer 37, the first electrode layer 331 is located between the second insulating base material layer 335 and the spacer layer 37, and the second electrode layer 333 is located between the second insulating base material layer 335 and the spacer layer 37. Because the first insulating base material layer 313 is arranged on the outermost side of the touch panel 103, the common electrode layer 311 can be prevented from being easily damaged. In one implementation, the first insulating base material layer 313 and the second insulating base material layer 335 are omitted. The common electrode layer 311 is directly formed on a first surface of the spacer layer 37, and the first electrode layer 331 and the second electrode layer 333 are formed in different regions of a second surface of the spacer layer 37, so as to reduce the thickness of the electrode unit 30.

It can be understood that, the spacer layer 37 may also have a two-layer or multi-layer structure. For example, in an implementation, the spacer layer 37 includes a first bonding layer, a deformation layer, and a second bonding layer that are stacked, the first bonding layer is bonded between the common electrode layer 311 and the deformation layer, a partial region of the second bonding layer is bonded between the deformation layer and the first electrode layer 331, and another partial region of the second bonding layer is bonded between the deformation layer and the second electrode layer 333. The deformation layer may be an organic silicon layer.

Therefore, when the electrode unit 30 is subject to touch pressure, the touch pressure is transmitted to the deformation layer of the spacer layer 37 and causes a deformation, and a distance between the common electrode layer 311 and at least one of the first electrode layer 331 and the second electrode layer 333 changes and causes a change in a capacitance.

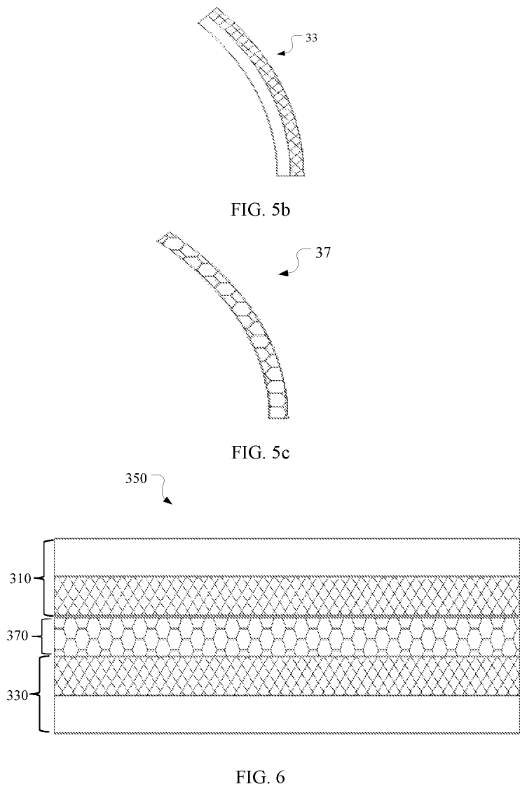

When the touch apparatus 100 is prepared, a prefabricated first sub-electrode, a prefabricated second sub-electrode, and a prefabricated spacer layer are prepared first. The prefabricated first sub-electrode, the prefabricated second sub-electrode, and the prefabricated spacer layer each have a substantial flat plate structure. Referring to FIG. 5a to FIG. 5c, the prefabricated first sub-electrode is processed into a first sub-electrode 31 with a certain curvature by using a hot bending mold or other methods. Similarly, the prefabricated second sub-electrode is processed into a second sub-electrode 33 with a certain curvature, and the prefabricated spacer layer is processed into a spacer layer 37 with a certain curvature. The first sub-electrode 31, the spacer layer 37, and the second sub-electrode 33 are sequentially stacked together to form the electrode unit 30.

A plurality of electrode units 30 are spliced and attached to the curved surface 11 of the base 10, and the plurality of electrode units 30 are electrically connected to the processor 105 through leads and packaged into a touch apparatus 100 with a spherical curved surface. Each first region 113 is provided with one electrode unit 30.

The leads may be formed at a time when the common electrode layer 311, the first electrode layer 331, and the second electrode layer 333 are formed. It can be understood that, in other implementations, the electrode units 30 may be connected to the processor 105 through flexible lines such as conductive adhesive, solder paste, upper and lower via, or other physical methods.

In an implementation, FIG. 6 is a schematic sectional view illustrating a prefabricated electrode unit according to an implementation of the present disclosure. A prefabricated first sub-electrode 310, a prefabricated spacer layer 370, and a prefabricated second sub-electrode 330 are sequentially stacked together to form a prefabricated electrode unit 350, and the prefabricated electrode unit 350 has a flat plate structure. The prefabricated electrode unit 350 is processed into an electrode unit 30 with a certain curvature by using a hot bending mold or other methods.

The following briefly describes how the touch apparatus 100 identifies an input instruction.

In the implementation, based on the principle of pressure-sensitive capacitance, the touch apparatus 100 changes a capacitance by changing a relative area between upper and lower electrode plates or a distance between the electrode plates or a deformation of a dielectric material of a capacitor, so as to receive and identify a capacitance change signal to implement an input instruction of touch pressure.

Referring back to FIG. 1, the touch apparatus 100 further includes a memory 106, and the memory 106 is configured to store a first reference capacitance value of the first capacitor and a second reference capacitance value of the second capacitor of each electrode unit 30. The first reference capacitance value is a capacitance value of the first capacitor of the electrode unit 30 in a state of no pressure touch, and the second reference capacitance value is a capacitance value of the second capacitor of the electrode unit 30 in a state of no pressure touch. The state of no pressure touch means that the touch panel 103 is in a state in which it is not subject to any pressure and is not deformed.

The following is described by using an example in which the common electrode layer 311 is located on a further outer side of the touch panel 103 relative to the first electrode layer 331 and the second electrode layer 333. When the touch panel 103 is in a state of pressure touch, the common electrode layer 311 is deformed due to stress, so that the capacitance of the first capacitor and the capacitance of the second capacitor change. Different pressure values cause different deformation amounts of the common electrode layer 311, and the different deformation amounts cause the first capacitor and the second capacitor to have corresponding capacitance variations. Therefore, a capacitance variation corresponds to a pressure value.

The processor 105 senses current capacitance values of the first capacitor and the second capacitor of each electrode unit 30. The processor 105 compares the current capacitance value of the first capacitor of each electrode unit 30 with the corresponding first reference capacitance value to obtain a first capacitance variation, and compares the current capacitance value of the second capacitor of each electrode unit 30 with the corresponding second reference capacitance value to obtain a second capacitance variation. The processor 105 determines a touch position based on the first capacitance variation and/or the second capacitance variation. In addition, the processor 105 determines a pressure value of pressing on the touch panel 103 based on the first capacitance variation and/or the second capacitance variation. As such, the processor 105 obtains touch parameters including at least the touch position and the pressure value, and the processor 105 performs corresponding control based on the touch parameters, for example, performs different control based on the pressure value. For example, when a user is viewing a photo, a larger pressure value indicates that the user controls to zoom in the photo to a larger scale. Each electrode unit 30 corresponds to a touch position coordinate in advance. The determining, by the processor 105, a touch position based on the first capacitance variation and/or the second capacitance variation includes: when at least one of the first capacitance variation and the second capacitance variation exceeds a preset threshold, the processor 105 determines that a touch has occurred, and determines that a touch position coordinate of the electrode unit 30 that encounters the first capacitance variation and/or the second capacitance variation is the touch position.

In an implementation, proportional relationship constants between different deformation amounts and different pressure values are pre-stored in a database. For example, it is assumed that when a deformation amount of the common electrode layer 311 is ΔL1, a proportional relationship constant between ΔL1 and a pressure value F1 is α1. When an object such as a finger or a stylus touches an electrode unit 30 of the touch panel 103 with pressure, the processor 105 obtains a first capacitance variation and a second capacitance variation. The processor 105 performs calculation based on one of the first capacitance variation and the second capacitance variation to obtain a deformation amount ΔL1, and the processor 105 can obtain a pressure value F1 of the touch based on the deformation amount ΔL1 and α1.

Based on the first capacitance variation and the second capacitance variation, the processor 105 can further determine a direction of an acting force posed by the object such as the finger or the stylus on the touch panel 103, especially a direction of a force applied along the curved surface of the touch panel 103 or parallel to the curved surface of the touch panel 103.

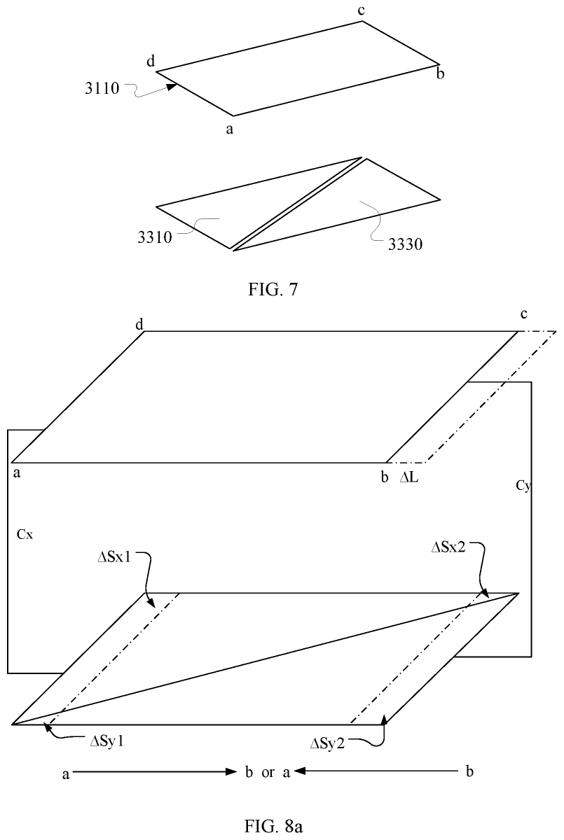

FIG. 7 is a schematic diagram illustrating projections of a common electrode layer, a first electrode layer, and a second electrode layer of the electrode unit shown in FIG. 3. In the implementation, a common electrode orthographic projection 3110 of the common electrode layer 311 on a projection plane is substantially rectangular, a first electrode orthographic projection 3310 of the first electrode layer 331 on the projection plane is a substantial right triangle, a second electrode orthographic projection 3330 of the second electrode layer 333 on the projection plane is a substantial right triangle, a hypotenuse of the first electrode orthographic projection 3310 is adjacent to and spaced from a hypotenuse of the second electrode orthographic projection 3330, and the first electrode orthographic projection 3310 and the second electrode orthographic projection 3330 form a rectangle. The projection plane is a plane perpendicular to a stacking direction of the common electrode layer 311 and the first electrode layer 331 or the second electrode layer 333.

An area of the common electrode layer 311 is greater than the sum of an area of the first electrode layer 331 and an area of the second electrode layer 333, and outer edges of the orthographic projection of the common electrode layer 311 on the projection plane coincide with outer edges of the orthographic projections of the first electrode layer 331 and the second electrode layer 333 on the projection plane.

It is assumed that four endpoints of the common electrode orthographic projection 3110 are a, b, c, and d, where a side ab and a side cd are long sides of the common electrode orthographic projection 3110, and a side be and a side da are short sides of the common electrode orthographic projection 3110; a long side of the first electrode orthographic projection 3310 and a long side of the second electrode orthographic projection 3330 have a similar length as the side ab and the side cd, and a short side of the first electrode orthographic projection 3310 and a short side of the second electrode orthographic projection 3330 have a similar length as the side be and the side da.

Generally, when the user touches the touch panel 103 with the pressure, the object such as the finger or the stylus comes into contact with the touch panel 103 for a very short time. To ensure processing accuracy, in the implementation, the processor 105 adopts a frequency division (segmented time, i.e., detection is performed on different capacitors at different time) detection method to determine the direction of the force posed by the object such as the finger or the stylus on the touch panel 103.

The processor 105 detects a first capacitance variation ΔCx of the first capacitor during a first detection time period (denoted as T1); and the processor 105 detects a second capacitance variation ΔCy of the second capacitor during a second detection time period (denoted as T2).

It is assumed that

$$K = \frac{Δ Cx}{Δ Cy} , Z = \frac{1}{K} = \frac{Δ {C}_{y}}{Δ Cx} .$$

### According to

$$C = \frac{ɛ S}{4 π kd} ,$$

where ε is a medium dielectric constant (relative dielectric constant), an electrostatic force constant is k=8.9880×10\hat{ }9, a unit is N·m²/C² (Newton·meter²/Coulomb²), π is 3.1415926 . . . , S is a relative area between two electrode plates of a capacitor, and d is a vertical distance between the two electrode plates, then

$$K = \frac{Δ Cx}{Δ Cy} = \frac{Δ {S}_{x}}{Δ {S}_{y}} ; Z = \frac{1}{K} = \frac{Δ {C}_{y}}{Δ Cx} = \frac{Δ {S}_{y}}{Δ {S}_{x}} ,$$

where ΔSₓ is a variation of the relative area between the common electrode layer 311 and the first electrode layer 331 of the first capacitor when the electrode unit 30 is stressed and deformed, and ΔS_{y} is a variation of the relative area of the common electrode layer 311 and the second electrode layer 333 of the second capacitor when the electrode unit 30 is stressed and deformed. For simplicity of description, the common electrode layer 311 has the same shape as the common electrode orthographic projection 3110, the first electrode layer 331 has the same shape as the first electrode orthographic projection 3310, and the second electrode layer has the same shape as the second electrode orthographic projection 3330. It is assumed that the length of the electrode unit 30 is L and the width of the electrode unit 30 is W.

The processor 105 identifies a direction of the pressure within a plane parallel to the common electrode layer 311 based on the detected K. Further, in some cases, when a change in K is not obvious and a change in Z is more obvious, the processor 105 identifies the direction of the pressure within the plane parallel to the common electrode layer 311 based on the detected Z, so as to improve the detection accuracy.

When a material is stressed, a micro deformation amount ΔL of the material in a direction of a force is limited. It is assumed that the first capacitance variation ΔCₓ has the maximum value ΔCₓ₋ₘₐₓ and the second capacitance variation ΔC_{y} has the maximum value ΔC_{y-max}; similarly, K has the maximum value Kₘₐₓ and the minimum value Kₘᵢₙ, and Z has the maximum value Zₘₐₓ and the minimum value Zₘᵢₙ.

When the direction of the pressure on the common electrode layer 311 is parallel to a straight line including the endpoint a and the endpoint b and runs from the endpoint a towards the endpoint b (i.e., a-b), ΔCₓ corresponds to a variation ΔSₓ₁ of the relative area between the common electrode layer 311 and the first electrode layer 331 of the first capacitor, ΔCₓ₋ₘₐₓ corresponds to the maximum variation ΔSₓ₁₋ₘₐₓ of the relative area between the common electrode layer 311 and the first electrode layer 331 of the first capacitor, ΔC_{y} corresponds to a variation ΔS_{y1} of the relative area between the common electrode layer 311 and the second electrode layer 333 of the second capacitor, and ΔC_{y-max} corresponds to the maximum variation ΔS_{y1-max} of the relative area between the common electrode layer 311 and the second electrode layer 333 of the second capacitor.

When the direction of the pressure on the common electrode layer 311 is parallel to a straight line including the endpoint a and the endpoint b and runs from the endpoint b towards the endpoint a (i.e., b-a), ΔCₓ corresponds to a variation ΔSₓ₂ of the relative area between the common electrode layer 311 and the first electrode layer 331 of the first capacitor, ΔCₓ₋ₘₐₓ corresponds to the maximum variation ΔSₓ₂₋ₘₐₓ of the relative area between the common electrode layer 311 and the first electrode layer 331 of the first capacitor, ΔC_{y} corresponds to a variation ΔS_{y2} of the relative area between the common electrode layer 311 and the second electrode layer 333 of the second capacitor, and ΔC_{y-max} corresponds to the maximum variation ΔS_{y2-max} of the relative area between the common electrode layer 311 and the second electrode layer 333 of the second capacitor.

Similarly, when the direction of the pressure on the common electrode layer 311 is parallel to a straight line including the endpoint a and the endpoint d and runs from the endpoint d towards the endpoint a (i.e., d-a), ΔCₓ corresponds to a variation ΔSₓ₃ of the relative area between the common electrode layer 311 and the first electrode layer 331 of the first capacitor, ΔCₓ₋ₘₐₓ corresponds to the maximum variation ΔSₓ₃₋ₘₐₓ of the relative area between the common electrode layer 311 and the first electrode layer 331 of the first capacitor, ΔC_{y} corresponds to a variation ΔS_{y3} of the relative area between the common electrode layer 311 and the second electrode layer 333 of the second capacitor, and ΔC_{y-max} corresponds to the maximum variation ΔS_{y3-max} of the relative area between the common electrode layer 311 and the second electrode layer 333 of the second capacitor.

When the direction of the pressure on the common electrode layer 311 is parallel to a straight line including the endpoint a and the endpoint d and runs from the endpoint a towards the endpoint d (i.e., a-d), ΔCₓ corresponds to a variation ΔSₓ₄ of the relative area between the common electrode layer 311 and the first electrode layer 331 of the first capacitor, ΔCₓ₋ₘₐₓ corresponds to the maximum variation ΔSₓ₄₋ₘₐₓ of the relative area between the common electrode layer 311 and the first electrode layer 331 of the first capacitor, ΔC_{y} corresponds to a variation ΔS_{y4} of the relative area between the common electrode layer 311 and the second electrode layer 333 of the second capacitor, and ΔC_{y-max} corresponds to the maximum variation ΔS_{y4-max} of the relative area between the common electrode layer 311 and the second electrode layer 333 of the second capacitor.

ΔL depends on a characteristic of the material itself. When each value reaches ΔLₘₐₓ, ΔSₓ₁₋ₘₐₓ and ΔSₓ₃₋ₘₐₓ may be the same. Based on K and the maximum value of K, the processor 105 can determine that the direction of the pressure is parallel to the straight line including the endpoint a and the endpoint b and runs from the endpoint a towards the endpoint b (i.e., a-b), or is parallel to the straight line including the endpoint a and the endpoint d and runs from the endpoint a towards the endpoint d (i.e., a-d), and Z may serve as a supplement to K to verify the direction.

When each value reaches ΔLₘₐₓ, ΔS_{y2-max} and ΔS_{y4-max} may be the same. Based on Z and the maximum value of Z, the processor 105 can determine that the direction of the pressure is parallel to the straight line including the endpoint a and the endpoint b and runs from the endpoint b towards the endpoint a (i.e., b-a), or is parallel to the straight line including the endpoint a and the endpoint d and runs from the endpoint d towards the endpoint a (i.e., d-a), and K may serve as a supplement to Z to verify the direction.

An example is given below for simple and exemplary description. It is assumed that the electrode unit 30 has a length L=100, a width W=100T, and

$$\frac{W}{L} = T = \frac{1}{2} .$$

Due to the limited micro deformation amount ΔL of the material in the direction of the force, for example, when the length L is 100 units, the maximum ΔL of the material is generally 10 units. It is assumed that the smallest deformation amount detectable is 0.1 unit.

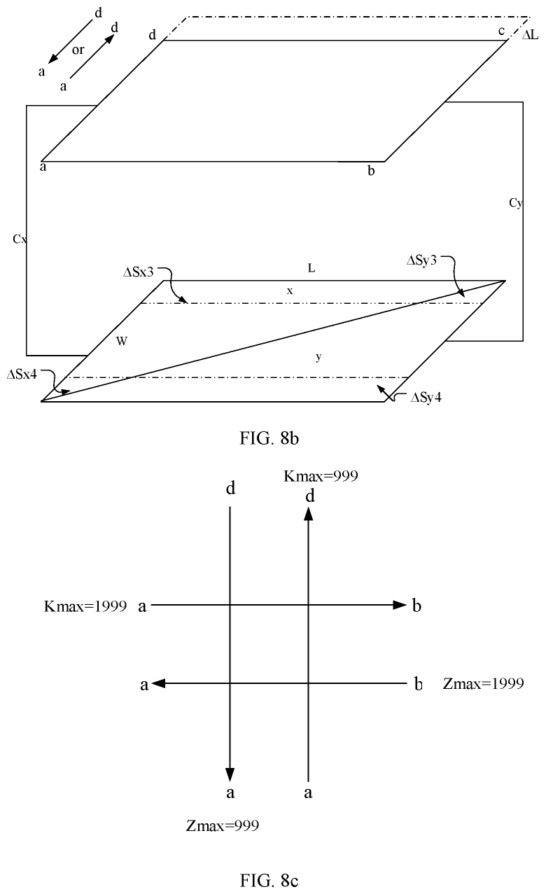

In a first case, referring to FIG. 8a and FIG. 8c, when the direction of the pressure on the common electrode layer 311 is a-b, K and Z are as follows:

$$K = \frac{Δ Cx}{Δ Cy} = \frac{Δ {S}_{x 1}}{Δ {S}_{y 1}} = \frac{( Δ L \times 100 T - Δ L \times T \times \frac{Δ L}{2} )}{Δ L \times T \times \frac{Δ L}{2}} = \frac{200}{Δ L} - 1$$

$$Z = \frac{Δ {C}_{y}}{Δ Cx} = \frac{Δ L}{200 T - Δ L}$$

As such, when the deformation amount is 0.1 unit, Kₘₐₓ=1999, and when the deformation amount reaches the maximum 10 units, Kₘᵢₙ=19; likewise, Zₘₐₓ= 1/19, and Zₘᵢₙ= 1/1999. When the processor 105 detects that K starts to decrease from Kₘₐₓ=1999, the direction of the pressure on the common electrode layer 311 is identified as a-b, and Zₘᵢₙ= 1/1999.

In a second case, referring to FIG. 8a and FIG. 8c, when the direction of the pressure on the common electrode layer 311 is b-a, K and Z are as follows:

$$K = \frac{Δ Cx}{Δ Cy} = \frac{Δ {S}_{x 2}}{Δ {S}_{y 2}} = \frac{Δ L \times T \times \frac{Δ L}{2}}{Δ L \times 100 T - Δ L \times T \times \frac{Δ L}{2}} = \frac{Δ L}{200 - Δ L}$$

$$Z = \frac{Δ {C}_{y}}{Δ Cx} = \frac{200}{Δ L} - 1$$

Kₘₐₓ= 1/19, and Kₘᵢₙ= 1/1999; and Zₘₐₓ=1999, and Zmiₙ=19. When the processor 105 detects that Z starts to decrease from Zₘₐₓ=1999, the direction of the pressure on the common electrode layer 311 is identified as b-a, and Kₘᵢₙ= 1/1999.

In a third case, referring to FIG. 8b and FIG. 8c, when the direction of the pressure on the common electrode layer 311 is d-a, K and Z are as follows:

$$K = \frac{Δ Cx}{Δ Cy} = \frac{Δ {S}_{x 3}}{Δ {S}_{y 3}} = \frac{Δ L \times 100 - Δ L \times Δ L \times \frac{T}{2}}{Δ L \times Δ L \times \frac{T}{2}} = \frac{200 T - Δ L}{Δ L}$$

$$Z = \frac{Δ {C}_{y}}{Δ Cx} = \frac{Δ L \times Δ L \times \frac{T}{2}}{Δ L \times 100 - Δ L \times Δ L \times \frac{T}{2}} = \frac{Δ L}{200 T - Δ L}$$

Kₘₐₓ=999, and Kₘᵢₙ=19; and Zₘₐₓ= 1/19, and Zₘᵢₙ= 1/999. When the processor 105 detects that K starts to decrease from Kₘₐₓ=999, the direction of the pressure on the common electrode layer 311 is identified as d-a, and Zₘᵢₙ= 1/999.

In a fourth case, referring to FIG. 8b and FIG. 8c, when the direction of the pressure on the common electrode layer 311 is a-d, K and Z are as follows:

$$K = \frac{Δ Cx}{Δ Cy} = \frac{Δ {S}_{x 4}}{Δ {S}_{y 4}} = \frac{Δ L \times Δ L \times \frac{T}{2}}{Δ L \times 100 - Δ L \times Δ L \times \frac{T}{2}} = \frac{Δ L}{200 T - Δ L}$$

$$Z = \frac{Δ {C}_{y}}{Δ Cx} = \frac{Δ L \times 100 - Δ L \times Δ L \times \frac{T}{2}}{Δ L \times Δ L \times \frac{T}{2}} = \frac{200 T - Δ L}{Δ L}$$

Kₘₐₓ= 1/19, and Kₘᵢₙ= 1/999; and Zₘₐₓ=999, and Zₘᵢₙ=19. When the processor 105 detects that Z starts to decrease from Zₘₐₓ=999, the direction of the touch on the common electrode layer 311 is identified as a-d, and Kₘᵢₙ= 1/999.

In conclusion, forces applied in the four directions can be determined by detecting change scopes of K and Z. In particular, for a common electrode layer with a large difference between its length and width, because Kₘₐₓ and Zₘₐₓ of different force directions are different, a specific force direction can be determined by determining values of Kₘₐₓ or Zₘₐₓ and changing trends thereof.

In addition, by setting a ratio of the length to width of the common electrode layer 311, the capacitance variations of the first capacitor and the second capacitor generated when the direction of the force produced by the object such as the finger or the stylus runs from the endpoint a towards the endpoint d or from the endpoint d towards the endpoint a, can be much less than the capacitance variations generated when the direction of the force produced by the object such as the finger or the stylus runs from the endpoint a towards the endpoint b or from the endpoint b towards the endpoint a.

In addition, the processor 105 further determines a touch action based on a capacitance variation holding time and a capacitance recovery time of at least one of the first capacitor and the second capacitor. For example, a force Fn is applied, the electrode unit 30 has a deformation of Ln, a holding time of the first capacitance variation ΔCₓ of the first capacitor is ΔTn, and ΔTb is preset as a standard time. When ΔTn>>ΔTb, the processor 105 considers that the touch action is a press; and when ΔTn<<ΔTb, the processor 105 considers that the touch action is a tap. It can be understood that, the processor 105 determines and identifies a user's touch action based on different preset capacitance variation references, recovery time references, holding time references, interval time references between two consecutive pressure touches, etc., and performs different control based on different touch actions, to implement rich control functions through a single pressure-sensitive element.

In some embodiments, the processor 105 performs corresponding function control based on both a touch action and touch parameters of the touch action. Therefore, the control functions implementable by a single pressure-sensitive element are further enriched.

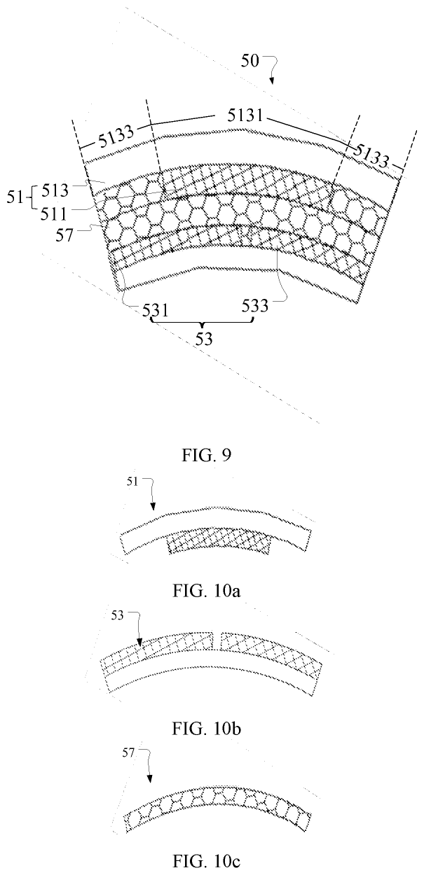

FIG. 9 is a schematic sectional view illustrating an electrode unit according to a second implementation of the present disclosure. An electrode unit 50 differs from the electrode unit 30 provided in the first implementation in that an area of a common electrode layer 511 is less than the sum of an area of a first electrode layer 531 and an area of a second electrode layer 533, and an orthographic projection of the common electrode layer 511 on a projection plane is located within orthographic projections of the first electrode layer 531 and the second electrode layer 533 on the projection plane. The first electrode layer 531 is at least partially arranged opposite to the common electrode layer 511, and the second electrode layer 533 is at least partially arranged opposite to the common electrode layer 511.

Specifically, a first insulating base material layer 513 includes a first placement region 5131 and a second placement region 5133 connected to the first placement region 5131, the common electrode layer 511 is distributed in the first placement region 5131, and a spacer layer 57 covers the common electrode layer 511 and the second placement region 5133.

When the electrode unit 50 is prepared, a prefabricated first sub-electrode, a prefabricated second sub-electrode, and a prefabricated spacer layer are prepared first. The prefabricated first sub-electrode, the prefabricated second sub-electrode, and the prefabricated spacer layer each have a substantially flat plate structure. Referring to FIG. 10a to FIG. 10c, the prefabricated first sub-electrode is processed into a first sub-electrode 51 by using a hot bending mold or other methods; similarly, the prefabricated second sub-electrode is processed into a second sub-electrode 53, and the prefabricated spacer layer is processed into a spacer layer 57. The first sub-electrode 51, the spacer layer 57, and the second sub-electrode 53 are sequentially stacked together to form the electrode unit 50.

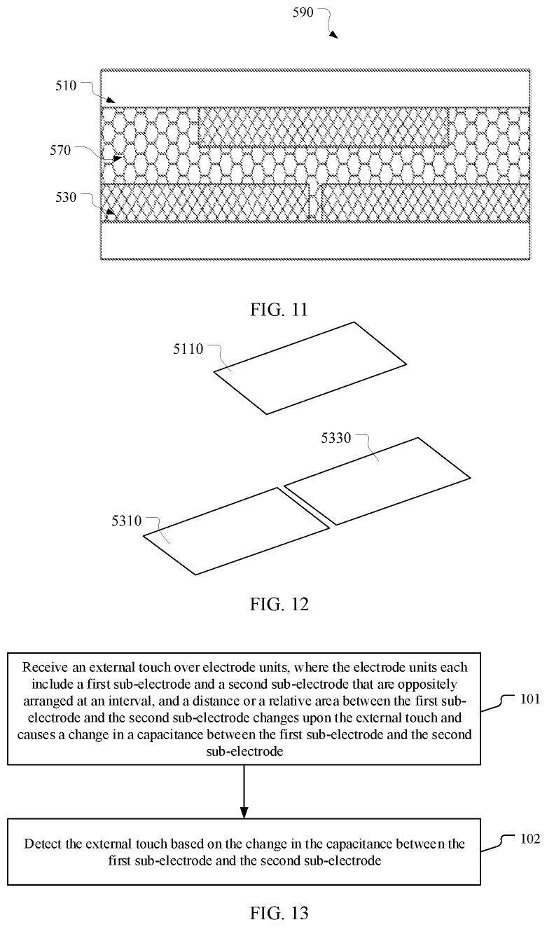

In an implementation, FIG. 11 is a schematic sectional view illustrating a prefabricated electrode unit according to an implementation of the present disclosure. A prefabricated first sub-electrode 510, a prefabricated spacer layer 570, and a prefabricated second sub-electrode 530 are sequentially stacked together to form a prefabricated electrode unit 590, and the prefabricated electrode unit 590 has a flat plate structure. The prefabricated electrode unit 590 is processed into an electrode unit 50 with a certain curvature by using a hot bending mold or other methods.

FIG. 12 is a schematic diagram illustrating projections of a common electrode layer, a first electrode layer, and a second electrode layer of the electrode unit shown in FIG. 9. In the implementation, a common electrode orthographic projection 5110 of the common electrode layer 511 on a projection plane is substantially rectangular, a first electrode orthographic projection 5310 of the first electrode layer 531 on the projection plane is substantially rectangular, and a second electrode orthographic projection 5330 of the second electrode layer 533 on the projection plane is substantially rectangular.

Referring to FIG. 13, the present disclosure further provides a touch detection method, including the following steps:

Step 101: an external touch is received by electrode units, where each of the electrode units includes a first sub-electrode and a second sub-electrode that are oppositely arranged at an interval, and a distance or a relative area between the first sub-electrode and the second sub-electrode changes upon the external touch, and causes a change in a capacitance between the first sub-electrode and the second sub-electrode.

Step 102: the external touch is detected based on the change in the capacitance between the first sub-electrode and the second sub-electrode.

The external touch is detected based on the change in the capacitance between the first sub-electrode and the second sub-electrode includes: a change in the distance between the first sub-electrode and the second sub-electrode is determined through the change in the capacitance, and a pressing force of the external touch is determined.

The external touch is detected based on the change in the capacitance between the first sub-electrode and the second sub-electrode includes: a change in the relative area between the first sub-electrode and the second sub-electrode is determined through the change in the capacitance, and a force direction of the external touch is determined.

The first sub-electrode includes a common electrode layer, the second sub-electrode includes a first electrode layer and a second electrode layer that are arranged at an interval, the common electrode layer and the first electrode layer form a first capacitor, and the common electrode layer and the second electrode layer form a second capacitor.

When the electrode units receive the external touch, a relative area between the first electrode layer and the common electrode layer changes to generate a first area variation, and a relative area between the second electrode layer and the common electrode layer changes to generate a second area variation.

The touch detection method further includes: the force direction of the external touch is determined via a ratio of the first area variation to the second area variation.

The force direction of the external touch is parallel to a touch surface of each of the electrode units.

The foregoing descriptions are preferred embodiments of the present disclosure. It should be noted that a person of ordinary skill in the art may make several improvements or polishing without departing from the principle of the present disclosure and the improvements or polishing shall fall within the protection scope of the present disclosure.

1. A touch panel, comprising a base and electrode units arranged on the base, wherein the electrode units each comprise a first sub-electrode and a second sub-electrode that are arranged opposite to each other at an interval, and when the electrode unit is pressed, a distance or a relative area between the first sub-electrode and the second sub-electrode changes and causes a change in a capacitance between the first sub-electrode and the second sub-electrode.

2. The touch panel according to claim 1, wherein the first sub-electrode comprises a common electrode layer, the second sub-electrode comprises a first electrode layer and a second electrode layer, the common electrode layer is arranged opposite to the first electrode layer to form a first capacitor, and the common electrode layer is arranged opposite to the second electrode layer to form a second capacitor.

3. (canceled)

4. The touch panel according to claim 2, wherein the electrode unit further comprises a spacer layer, the common electrode layer is disposed on one side of the spacer layer, and the first electrode layer and the second electrode layer are disposed in different regions on the other side of the spacer layer away from the common electrode layer.

5. The touch panel according to claim 4, wherein the first sub-electrode further comprises a first insulating base material layer, the common electrode layer is formed on the first insulating base material layer, the common electrode layer is located between the first insulating base material layer and the spacer layer, the second sub-electrode further comprises a second insulating base material layer, the first electrode layer and the second electrode layer are formed on the second insulating base material layer, the first electrode layer is located between the second insulating base material layer and the spacer layer, and the second electrode layer is located between the second insulating base material layer and the spacer layer.

6. (canceled)

7. (canceled)

8. (canceled)

9. The touch panel according to claim 2, wherein outer edges of an orthographic projection of the common electrode layer on a projection plane coincide with outer edges of orthographic projections of the first electrode layer and the second electrode layer on the same projection plane.

10. The touch panel according to claim 9, wherein the orthographic projection of the common electrode layer on the projection plane is rectangular, a first electrode orthographic projection of the first electrode layer on the projection plane is a right triangle, a second electrode orthographic projection of the second electrode layer on the projection plane is a right triangle, a hypotenuse of the first electrode orthographic projection is adjacent to and spaced from a hypotenuse of the second electrode orthographic projection, and the first electrode orthographic projection and the second electrode orthographic projection form a rectangle.

11. The touch panel according to claim 2, wherein an area of the common electrode layer is less than a sum of an area of the first electrode layer and an area of the second electrode layer.

12. The touch panel according to claim 1, wherein the base has a spherical structure, and a plurality of electrode units are provided and independently attached to the base.

13. The touch panel according to claim 12, wherein the base comprises a plurality of first regions and a plurality of second regions, the first regions each are surrounded by corresponding ones of the second regions, and each of the electrode units is arranged in one of the first regions.

14. The touch panel according to claim 13, wherein a side of each of the first regions is a side of an adjacent second region, the first regions each are an equilateral pentagonal region, and the second regions each are an equilateral hexagonal region.

15. (canceled)

16. The touch panel according to claim 12, wherein lines connecting respective centers of three adjacent electrode units form a triangle.

17. The touch panel according to claim 16, wherein arrangement directions of the three adjacent electrode units form included angles with each other.

18. The touch panel according to claim 17, wherein the arrangement direction of the three adjacent electrode units are parallel to sides of the triangle formed by the lines connecting the centers of the three adjacent electrode units, respectively.

19. The touch panel according to claim 17, wherein extension lines of the arrangement directions of the three adjacent electrode units jointly form a triangle.

20. The touch panel according to claim 16, wherein the arrangement directions of the three adjacent electrode units are parallel to each other.

21. A touch detection method, comprising:
receiving an external touch over electrode units, wherein the electrode units each comprise a first sub-electrode and a second sub-electrode that are arranged opposite to each other at an interval, and a distance or a relative area between the first sub-electrode and the second sub-electrode changes upon the external touch and further causes a change in a capacitance between the first sub-electrode and the second sub-electrode; and
detecting the external touch based on the change in the capacitance between the first sub-electrode and the second sub-electrode.

22. The touch detection method according to claim 21, wherein the detecting the external touch based on the change in the capacitance between the first sub-electrode and the second sub-electrode comprises: determining a change in the distance between the first sub-electrode and the second sub-electrode based on the change in the capacitance, and determining a pressing force of the external touch.

23. The touch detection method according to claim 21, wherein the detecting the external touch based on the change in the capacitance between the first sub-electrode and the second sub-electrode comprises: determining a change in the relative area between the first sub-electrode and the second sub-electrode based on the change in the capacitance, and determining a force direction of the external touch.

24. The touch detection method according to claim 21, wherein the first sub-electrode comprises a common electrode layer, the second sub-electrode comprises a first electrode layer and a second electrode layer that are arranged at an interval, the common electrode layer and the first electrode layer form a first capacitor, and the common electrode layer and the second electrode layer form a second capacitor.

25. The touch detection method according to claim 24, wherein when the electrode units receive the external touch, a relative area between the first electrode layer and the common electrode layer changes to generate a first area variation, and a relative area between the second electrode layer and the common electrode layer changes to generate a second area variation;
the touch detection method further comprises: determining a force direction of the external touch via a ratio of the first area variation to the second area variation.

26. (canceled)

27. (canceled)
